(19) United States
(12) Patent Application Publication
(10) Pub. No.: US 2004/0139442 A1
(43) Pub. Date: Jul. 15, 2004

(54) Task switching system, task switching method and dsp modem

(76) Inventor: Keiichi Miyamoto, Kanagawa (JP)

Correspondence Address: Cooper & Dunham, 1185 Avenue of the Americas, New York, NY, 10036, US

(21) Appl. No.: 10/475,422

(22) PCT Filed: Sep. 13, 2002
(86) PCT No.: PCT/JP02/09427

(30) Foreign Application Priority Data
Sep. 20, 2001 (JP) 2001-286670

(51) Int. Cl. G06F 9/46

(52) U.S. Cl. 718/108; 718/100

(57) ABSTRACT

A MODEM 1 has a one-chip single DSP 2, and the single DSP 2 executes a controller task (CT) and a data-pump task (DP). In the CT, a plurality of sub-tasks are continuously executed in the round robin mode in the CT task processing part 3. During the execution of the CT task, when the DP task is required to be started by an interrupt generated by an external event, the parameters for restarting the CT task that is being executed are stored in the task switching part 5, and then the task is switched from the CT task to the DP task according to the parameters for restarting the data-pump task, which are previously stored. Then, after the process of the switched DP task is finished, the parameters for restarting the DP task are stored and the task is, switched from the DP task to the CT task according to the parameters for restarting the CT task.

### TECHNICAL FIELD

The present invention relates to technology for switching tasks that are executed on a processor, and more particularly to a task switching system, a task switching method and a DSP MODEM, in which a plurality of tasks are effectively switched in a single processor.

### BACKGROUND ART

A single processor executes one task selected from a plurality of tasks. The task takes a state from a plurality of states, such as an executable state in which state the task can be executed by the processor, a running state in which state the task is being executed by the processor and a waiting state in which state the task cannot be executed by the processor. The executable tasks can be executed by the processor according to the priority of each task.

FIG. 1 shows an example of a task mode transition diagram.

FIG. 1 shows the task state transition diagram for a relatively simple real time operating system, hereinafter referred to as RTOS. The task takes various states, for example an executable state 41, a running state 42, a waiting state 43, a compulsory waiting state 44 and a dormant state 45.

For example, the task state is changed from the executable state 41 to the running state 42 when a run event is generated. The task state is changed from the executable state 41 to the compulsory waiting state 44 when a break event is generated. The task state is changed from the executable state 41 to the dormant state 45 when a compulsory termination event is generated. The task state is changed from the running state 42 to the executable state 41 when an execution wait event is generated. The task state is changed from the running state 42 to the waiting state 43 when a wait condition event is generated. The task state is changed from the running state 42 to the dormant state 45 when a termination event is generated.

The task state is changed from the waiting state 43 to the executable state 41 when a wait release event is generated. The task state is changed from the waiting state 43 to the compulsory waiting state 44 when a compulsory wait event is generated. The task state is changed from the waiting state 43 to the dormant state 45 when a compulsory termination event is generated. The task state is changed from the waiting state 44 to the executable state 41 when a restart event is generated. The task state is changed from the dormant state 45 to the executable state 41 when a start event is generated.

The task is started according to an event or a state transition, and is terminated after a desired operation is finished.

Next, conventional task management technology will be explained. A MODEM has two main functions, which are transaction control and signal processing.

Examples of transaction control are user-issued AT command processing, S-register processing, conversion processing from digital bit data to digital byte data, buffering, error correction, and data compression and decompression. The transaction control is called a controller task.

An example of signal processing is modulation and demodulation, in which digital bit data are modulated to a transmission signal that is transmitted through the transmission line and the transmission signal received from the transmission line is demodulated to digital bit data. The signal processing is called a data-pump task.

Conventionally, the controller task is performed by a software program running on a general purpose CPU (Central Processing Unit) such as a micro-computer, and the data-pump task is performed by a hardware device, such as a DSP (digital signal processor), dedicated to signal processing.

However, recently, technology for the DSP has advanced and thereby the processing ability as measured in MIPS (Millions of Instruction Per Second) is significantly increased. Therefore, there is a need to provide a MODEM by using a one chip DSP in order to cut the cost of the product and reduce the size of the product.

Generally, a multi-tasking RTOS is used to implement the multi-tasking system, such as the MODEM, running on the DSP.

Although the RTOS is general-purpose and can process a plurality of complicated tasks, it also requires DSP resources. Further, it is required to design the tasks to be executed by the RTOS according to specifications of the RTOS.

Generally, in the real time system, a plurality of tasks are frequently started at the same time. One task requires a relatively long time to be executed and another task requires a relatively short time to be executed. The RTOS controls the execution and waiting of these tasks when such operations are required.

The RTOS is required to hold state information for every task to properly control the task. It is also required for a task to have a mechanism to notify of the RTOS start timing and priority of the task.

Because the RTOS itself is also executed by the processor, the size of the RTOS is also included in the total amount of software needed in memory and execution time of the RTOS is also included in the total amount of execution time needed, respectively. A mechanism to switch between the RTOS and the tasks is also needed.

The task switching technology is described in, for example, Japanese. Laid-Open Patent Application No.2000-105708, Japanese Laid-Open Patent Application No.2000-142065 and Japanese Laid-Open Patent Application No.2000-215068.

On the other hand, in the low cost and reduced sized DSP, a stack area is reduced to be as small as possible. Further, it is required to have the stack area controlled by software in memory to implement the RTOS mentioned above. As a result, the software structure becomes very complicated and the RTOS cannot be executed effectively.

Therefore, it is a requirement for a MODEM using such a small-sized and low cost DSP to effectively execute two tasks, which are the controller task and the data-pump task, without using the complete RTOS. However, it is not possible to provide such a MODEM using prior art technology.

In the prior art technology, it is not possible to effectively switch among a plurality of tasks in the single processor. For example, it is not possible to effectively execute two tasks, which are the controller task and the data-pump task, without using the complete RTOS, in the MODEM using a small-sized and low cost DSP.

### DISCLOSURE OF THE INVENTION

Accordingly, it is a general object of the present invention to provide a task switching system, a task switching method and a DSP MODEM, in which the above-described disadvantage is eliminated.

A more specific object of the present invention is to provide a task switching system, a task switching method and a DSP MODEM, which are constructed by a small-sized and low cost one-chip DSP.

The above objects of the present invention are achieved by a task switching system, a task switching method and a DSP MODEM in which a single processor executes a first task and a second task, a plurality of sub-tasks of the first task are continuously executed in a round robin mode, and the second task is executed when a predetermined event occurs, and the first task is restarted after the execution of the second task is finished. For example, in the MODEM using the one-chip DSP, the DSP executes a controller task (a MODEM controller task) and a data-pump task (a MODEM data-pump task) In the controller task, a plurality of sub-tasks are continuously executed in the round robin mode. During the execution of the controller task, when the data-pump task is required to be started by the interrupt generated by an external event, the parameters for restarting the controller task are stored, and then the task is switched from the controller task to the data-pump task according to the parameters for restarting the data-pump tasks which are previously stored. Then, after the process of the data-pump task is finished, the parameters for restarting the data-pump task are stored and the task is switched from the data-pump task to the controller task according to the parameters for restarting the controller task.

### BRIEF DESCRIPTION OF THE DRAWINGS

Other objects, features and advantages of the present invention will become more apparent from the following detailed description when read in conjunction with the accompanying drawings, in which:

FIG. 1 shows an example of a task state transition diagram;

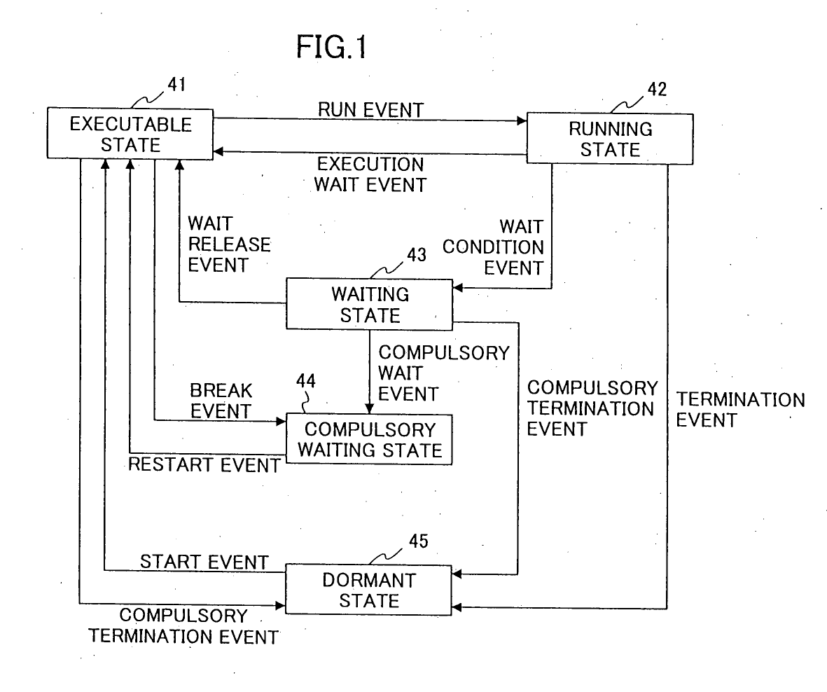

FIG. 2 shows a bock diagram of a task switching system and a MODEM of an embodiment according to the present invention;

FIG. 3 shows a hardware block diagram of the MODEM shown in FIG. 2; and

FIG. 4 shows a flow chart of procedures of the task switching system of the embodiment according to the present invention.

### BEST MODE FOR CARRYING OUT THE INVENTION

A description will now be given, with reference to the accompanying drawings, of embodiments of the present invention.

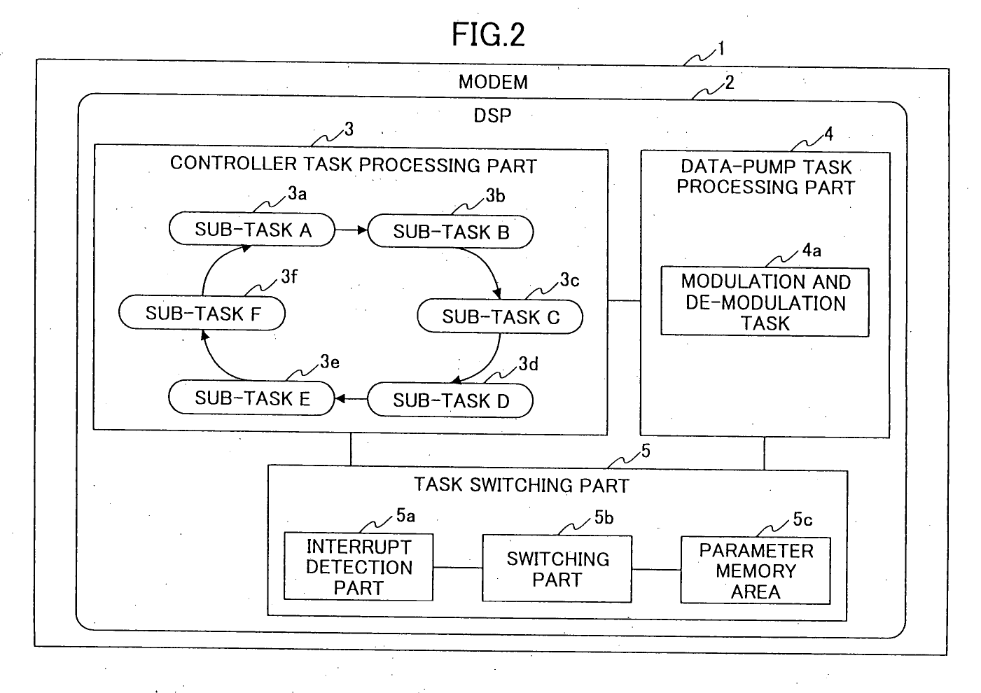

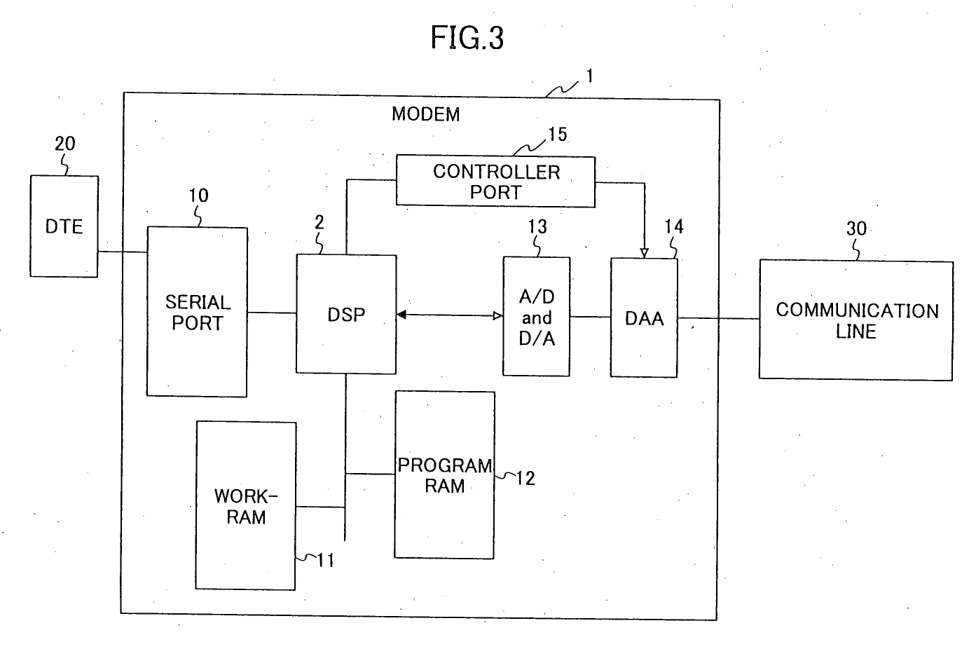

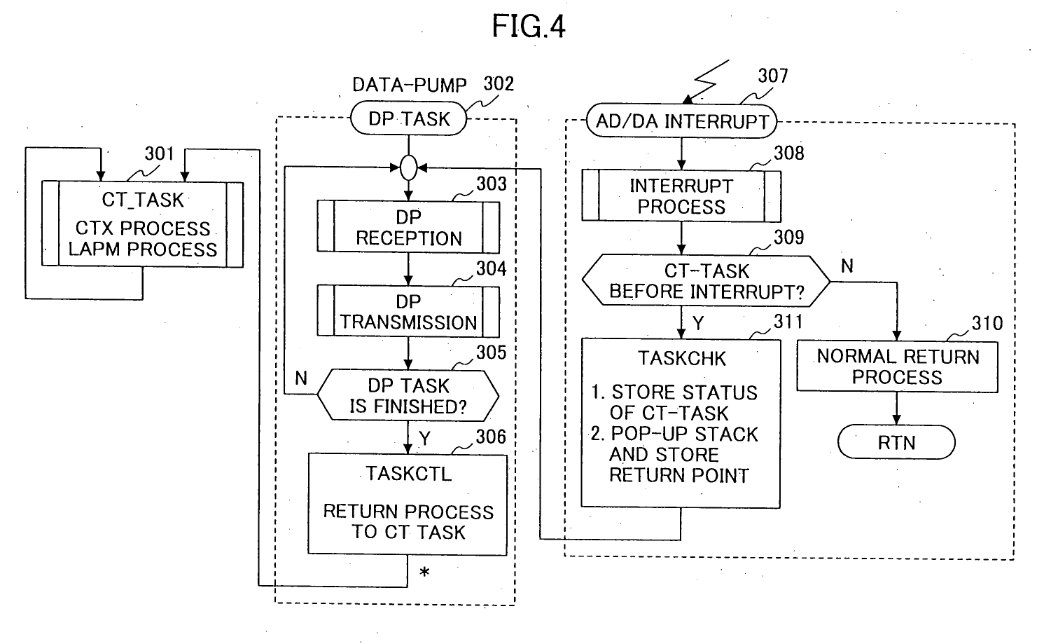

FIG. 2 shows a bock diagram of a task switching system and a MODEM of the embodiment according to the present invention. FIG. 3 shows a hardware block diagram of the MODEM shown in FIG. 2. FIG. 4 shows a flow chart of procedures of the task switching system of the embodiment according to the present invention.

In FIG. 3, reference numeral 1 shows a MODEM, reference numeral 20 shows a DTE (Data Terminal Equipment) constructed by, for example a personal computer, and reference numeral 30 shows a communication line. The MODEM 1 mainly has a DSP 2, a serial port 10, a work-RAM 11 (Random Access Memory), a program ROM 12 (Read Only Memory), an A/D and D/A converter 13, a DAA 14 (Data Access Arranger) and a control port 15.

The DSP 2 is connected to the DTE 20 via the serial port 10 and performs the controller task with sub-tasks, such as connection control between the DTE 20 and the communication line 30, user-issued AT command processing, S-register processing, conversion processing from digital bit data to digital byte data, buffering, error correction, and data compression and decompression; and the data-pump task, such as modulation and demodulation, in which the digital bit data are modulated to a transmission signal that is transmitted through the transmission line and the transmission signal received from the transmission line is demodulated to digital bit data.

The processes performed by the DSP 2 are actually executed by a CPU in the DSP 2 according to a program stored on the program ROM 12. Further, the DSP 2 executes the task switching according to the present invention using the work-RAM 11.

The DAA 14 has a NCU (Network Control Unit) and a hybrid circuit. The DAA 14 performs both connection control to the communication line 30 and data transmission and reception control according to an instruction from the DSP 2 through the control port 15.

The data transmitted from and received by the DAA 14 is converted from digital signal to analog signal and from analog signal to digital signal by the A/D and D/A converter 13.

Therefore, in the MODEM 1, the digital signal to be transmitted is supplied from the DTE 20 and the digital signal is signal-processed and controlled by the DSP 2. Then, the digital signal supplied from the DSP 2 is converted to an analog signal by the A/D and D/A converter 13, and then sent to the communication line 30 through the DAA 14.

The analog signal received from the communication line 30 is supplied to the A/D and D/A converter 13 through the DAA 14, and then, the analog signal is converted to the digital signal by the A/D and D/A converter 13. The digital signal is signal-processed and controlled by the DSP 2, and supplied to the DTE 20 through the serial port 10.

The DSP 2 in the MODEM 1 has the structure shown in FIG. 2, and the DSP 2 can efficiently switch the task between the transaction control task such as the controller task, and the signal-processing task such as the data-pump task.

As shown in FIG. 2, the DSP 2 in the MODEM 1 has a controller task processing part 3, a data-pump task processing part 4 and a task switching part 5. In the controller task processing part 3, a plurality of sub-tasks A3a through F3f are continuously executed in a round robin mode. In the data-pump task processing part 4, a modulation and de-modulation task 4a is executed.

In the task switching part 5, an interrupt detection part 5a detects an external event interrupt, such as completion of conversion of a block by the A/D and D/A converter 13 shown in FIG. 3, and a switching part 5b stops the sub-tasks A3a through F3f being continuously executed by the controller task processing part 3 in the round robin mode and switches the task to the modulation and de-modulation task 4a.

When the task is switched, the switching part 5b stores information or parameters that are needed to restart the stopped sub-tasks A3a through F3f into a parameter memory area 5c in the work-RAM 11 shown in FIG. 3.

After the modulation and de-modulation task 4a is finished, the task switching part 5 stores parameters which are needed to restart the data-pump task processing part 4 into the parameter memory area 5c, and reads the parameters for restarting the sub-tasks A3a through F3f from the parameter memory area 5c, and then, switches the task to the sub-tasks A3a through F3f according to the parameters.

As a result, the DSP 2 in the MODEM 1 according to the present invention can switch the tasks without using the entire OS (Operating System). Therefore, the amount of memory to be used can be reduced.

Next, procedures of the task switching system used in the MODEM 1 and the DSP 2 will be explained with reference to FIG. 4.

After the DSP 2 is reset and initialized, at step 301, the controller task (CT_TASK), which is a normally processed task of the controller, is executed. This controller task is a one-level process having “a CTX process” and “a LAPM process”, and the controller task is continuously executed.

The CTX process has sub-tasks. Examples of the sub-tasks are AT command parser processing, S-register processing, conversion processing from digital bit data to digital byte data, buffering, and flow control for a host device.

The LAPM (Link Access Procedure for Modems) is the error correction process described in “V.42: error correction recommendation” of the ITU-T (International Telecommunication Union-Telecommunication standardization sector). Further, this controller task includes the data compression process, such as V.42bis, and so on.

Each task (each controller sub-task) processes data when the data to be processed exists, and proceeds to the next controller sub-task when no data to be processed exists, in the round robin mode.

The external event needed for the controller (CT) task is generated by the CT resource interrupt process, such as communication between the host device, or accumulation of either the de-modulated data supplied from the data-pump (DP) task or the data that will be supplied to the DP task for modulation.

While the “CT_TASK” is being processed, interrupts are allowed.

While the DP task does not require processing, the CT task is continuously executed in the round robin mode.

In step 302, for example, an input signal from the A/D converter in the A/D and D/A converter 13 is the start event for the DP reception process 303 of the data-pump (DP) task. Similarly, the timing at which data are supplied to the D/A converter in the A/D and D/A converter 13 is the external start event for the DP transmit process 304 of the data-pump (DP) task.

An AD/DA interrupt generated by the A/D and D/A converter 13 is processed at step 307. The AD/DA interrupt is a process which is started by a hardware interrupt generated by the A/D and D/A converter 13 connected to the DSP 2 at a time when the AD/DA conversion is finished.

The data are stored in a transmit/reception buffer. If the DP task is needed, the tasks of the DP main level are notified by means of a flag, ad so on.

After the process needed for the interrupt at step 308 is finished, at step 309, the task that was being executed before the interrupt is identified and the procedure is branched based on the identified result. If the task that was being executed before the interrupt is not the “CT_TASK”, then the procedure proceeds to the step 310 and the task which was being executed before the interrupt is restarted normally.

However, if the task that was being executed before the interrupt is the “CT_TASK”, then the task switching part 5 stores the status information of the “CT_TASK” (parameters such as registers or the next entry point that is needed for re-starting the task) into the parameter memory area 5c, and at step 311, the procedure jumps to the top of the DP process 302.

In this embodiment, the DP task is always switched to the CT task after the DP task is completely processed. Therefore, the DP task is switched from the CT task at the start of the DP task when the DP task is restarted.

The DP task is executed at the normally running level and no interrupt PC stack is used. When the next entry point (PC) is stored in this process, a malfunction of the stack does not occur because the PC stack is all popped-up.

Commonly, not every signal processing step needed for the DP task is executed in the interrupt process. This prevents the multiple interrupt system from failing because of a prolonged interrupt interval, and this is because a specific process must be executed using the plurality of sampled data according to a plurality of the AD interrupts (normally, one symbol of the MODEM consists of a plurality of samples). Therefore, it is required to switch the task to the DP task at the normally running level.

In the DP task 302, the signal processing, such as the reception or transmission of data, is executed at the steps 303 and 304 according to the requirement of the event generated by the AD/DA interrupt.

During the process, another process requirement may occur indicated by the AD/DA interrupt. Therefore, at step 305, whether a new DP task is generated is determined.

After the occurrence of the new DP task is determined, and if it is required to process the new DP task, the DP task 302 is continued. If it is not required to process the new DP task, the procedure advances to the “TASKCTL” process at step 306.

The “TASKCTL” process is a module that recovers the entry point and the register of the controller task (CT_TASK). At the step 306 of the “TASKCTL”, the procedure jumps to the entry point of “CT_TASK”, which was stored in the memory. As a result, the procedure advances to the step 301. The mark * shows the jump. The return address is different when the procedure jumps to the entry point of “CT_TASK”.

Returning to “CT_TASK” restarts the task that is stopped, at the step 301.

As described above, the controller task (CT_TASK) does not need to know that the data-pump task exists. This allows the controller task (program) to be described as one closed task (program). This is very convenient when the controller software that has been implemented on the conventional CPU is transplanted to the software implemented on another CPU.

The modulated and de-modulated data are used to interface the DP task with the CT task. This data sequence is stored in the memory constructed as a software FIFO (First In First Out) memory. The amount of data or no data in the memory works as a start event for both the DP task and the CT task.

The CT task also has an event started by an I/F signal from the host device, such as the AT command, and so on. Those I/F signals are checked by means of the interrupt process for the CT resource and polling, and so on.

As described above with reference to FIG. 2 through FIG. 4, in the task switching system, the task switching method, the DSP and the MODEM of the embodiment, the MODEM 1 has a one-chip single DSP 2, and the single DSP 2 executes the controller task (MODEM controller task) and the data-pump task (MODEM data-pump task). In the controller task, a plurality of sub-tasks are continuously executed in the round robin mode. During the execution of the controller task, when the data-pump task is required to be started by the interrupt generated by the external event, the parameters for restarting the controller task are stored, and then the task is switched from the controller task to the data-pump task according to the parameters for restarting the data-pump task that are previously stored. Then, after the process of the switched data-pump task is finished, the parameters for restarting the data-pump task are stored and the task is switched from the data-pump task to the controller task according to the parameters for restarting the controller task.

This allows the controller task to be described as a collection of closed sub-tasks (program). Further, when the data-pump task is required, the data-pump task is executed with higher priority.

According to this embodiment, it is possible to sufficiently switch tasks in the MODEM 1 without using a large scale and complicated RTOS.

The present invention is not limited to the specifically disclosed embodiments shown in FIG. 2 through FIG. 4, but variations and modifications may be made without departing from the scope of the present invention. For example, in the present embodiment, the task is switched between the controller task and data-pump task by the task switching part 5. However, the data-pump processing part 4 or the modulation and de-modulation task 4a can execute the task switching function in place of the task switching function being performed by the task switching part 5. In this case, the data-pump task (the data-pump processing part 4 or the modulation and de-modulation task 4a) that is being executed stores its own parameters in the memory for restarting the data-pump task itself when the data-pump task itself is finished, and switches the task from the data-pump task itself to the controller task according to the parameters stored for restarting the controller task.

In the embodiment, the DSP in the MODEM is used for implementing the present invention. However, it is possible to apply the present invention to an apparatus in which a plurality of tasks are effectively switched in a single processor. For example, the single processor executes the first task and the second task. In the first task, a plurality of sub-tasks are continuously executed in the round robin mode. During the execution of the first task, when the second task is required to be started by the interrupt generated by the external event, the parameters for restarting the first task are stored, and then the task is switched from the first task to the second task according to the parameter for restarting the second task that are previously stored. Then, after the process of the switched second task is finished, the parameters for restarting the second task are stored and the processing is switched from the second task to the first task according to the parameters for restarting the first task.

According to the present invention, it is possible to effectively switch a plurality of tasks in a single processor. For example, in the MODEM using the small-sized and low cost DSP, it is possible to effectively execute two tasks, which are the controller task and the data-pump task, without using the complete RTOS (Real Time Operating Sysyem). Therefore, it is possible to provide the small-sized and low cost MODEM using the one-chip DSP.

The present invention is not limited to the specifically disclosed embodiments, but variations and modifications may be made without departing from the scope of the present invention.

The present application is based on Japanese priority application No. 2001-286670 filed on Sep. 20, 2001, the entire contents of which are hereby incorporated by reference.

1. (Amended) A task switching system in a single processor, said task switching system comprising:
a first task processing unit that continuously executes a plurality of sub-tasks in a round robin mode;
a second task processing unit that executes a predetermined task when a corresponding predetermined event occurs; and
a task switching unit that makes said first task processing means stop execution of said sub-tasks and makes said second task processing means start execution of said predetermined task when said predetermined event occurs and when the first task: is being executed, and that makes said second task processing means continue execution of said predetermined task when said second task is being executed.

2. (Amended) A task switching method in a single processor that executes a first task and a second task, said task switching method comprising:
a first step that continuously executes a plurality of sub-tasks of said first task in a round robin mode;
a second step that stops execution of said first task and starts execution of said second task when a predetermined event occurs and when said first task is being executed; and
a third step that restarts execution of said first task after said execution of said second task is finished.

3. The task switching method as claimed in claim 2, wherein said second step further stores parameters for restarting said first task and restarts said second task according to previously stored parameters for restarting said second task, and said third step stores said parameters for restarting said finished second task and restarts said first task, which is stopped when said second task is restarted, according to said parameters for restarting said first task stored by said second task.

4. The task switching method as claimed in claims 2 or 3, wherein said predetermined event is an interrupt generated by an external event, and said second step stops said execution of said first task and starts said execution of said second task when said interrupt is generated during execution of said first task.

5. (Amended) A MODEM having a single DSP that switches a task between a controller task and a data-pump task and executes said task, said MODEM comprising:
a controller task processing unit that continuously executes a plurality of sub-tasks of said controller task in a round robin mode;
a data-pump task processing unit that executes said data-pump task when a predetermined event occurs and when said controller task is being executed; and
a task switching unit that makes said controller task processing means stop execution of said sub-tasks and makes said data-pump task processing means start execution of said data-pump task when said predetermined event occurs.

6. (Amended) A DSP that switches tasks and executes said tasks included in an apparatus having a MODEM, said DSP comprising:
a first task processing unit that continuously executes a plurality of sub-tasks in a round robin mode;
a second task processing unit that executes a predetermined task when a corresponding predetermined event occurs; and
a task switching unit that makes said first task processing means stop execution of said sub-tasks and makes said second task processing means start execution of said predetermined task when said predetermined event occurs and when said first task is being executed.
